(19) United States
(12) Patent Application Publication
(10) Pub. No.: US 2007/0088535 A1
(43) Pub. Date: Apr. 19, 2007

(54) Generic spectral model for imaging devices

(75) Inventor: Arkady Ten, Roseville, MN (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/251,706

(22) Filed: Oct. 17, 2005

(51) Int. Cl. G06F 13/10

(52) U.S. Cl. 703/21

(57) ABSTRACT

The invention is directed to generic spectral modeling techniques applicable to a variety of imaging devices. A generic spectral model may include a general channel model capable of modeling spectral characteristics of imaging devices and a look-up table (LUT) capable of compensating for cross-channel interaction and possibly other characteristics that are difficult to model, such as non-linear characteristics of imaging devices. In this way, the generic spectral model includes aspects of both a conventional physical model and a conventional brute force model. Digital values, i.e., pixel counts, of each channel of an imaging device are adjusted by the LUT of the generic spectral model to include cross-channel interaction. The channel model then accurately predicts spectral emissions for each channel of the imaging device based on the adjusted digital values. The generic spectral model converts the predicted spectral emissions to a device-independent color space.

### TECHNICAL FIELD

The invention relates to imaging devices and, more particularly, techniques for modeling spectral characteristics of imaging devices.

### BACKGROUND

Imaging devices typically include color software applications that use models to predict color or spectral output of the imaging devices. Examples of imaging devices include cathode ray tube (CRT) displays, liquid crystal displays (LCDs), plasma displays, digital light processing (DLP) displays, digital paper, photographic materials, or any device that renders images to a user. Conventional color software applications may use one of several types of models, such as physical models and “brute force” models.

Physical models are based on the actual physics of imaging devices. Brute force models are usually interpolation-based and typically use look-up tables (LUTs). The physical models usually deliver better accuracy relative to the brute force models since the physical models capture actual physical color behavior of the imaging devices. On the other hand, the physical models are highly specialized to specific imaging devices. For example, a physical model for a CRT display usually performs poorly if applied to an LCD display.

The brute force models (commonly LUT-based models) assume little or nothing of the actual physics of the imaging devices. As a result, the brute force models are more universally adaptable to a variety of imaging devices. In other words, a LUT-based model may perform reasonably well when predicting both CRT and LCD display color outputs. However, if an imaging device exhibits an essentially non-linear color response, a brute force model requires a significant number of nodes in the LUT and, consequently, a large number of measurements in order to satisfy accuracy requirements. Moreover the brute force models may exhibit interpolation and measurement noise related artifacts.

### SUMMARY

In general, the invention is directed toward a generic spectral model applicable to a variety of imaging devices. Examples of imaging devices include cathode ray tube (CRT) displays, liquid crystal displays (LCDs), plasma displays, digital light processing (DLP) displays, digital paper, photographic materials, or any device that renders images to a user. In one embodiment, the generic spectral model includes a general channel model capable of modeling spectral characteristics of imaging devices and a look-up table (LUT) capable of compensating cross-channel interaction and other characteristics that can be difficult to model, such as, non-linear characteristics of imaging devices. In this way, the generic spectral model includes aspects of both a conventional physical model and a conventional brute force model.

Imaging devices are typically multi-channel devices in the sense that multiple physical color channels represent every pixel on the display. For example, an imaging device may be an additive device comprising red, green, and blue (RGB) channels. Digital values, i.e., pixel counts, of each channel of an imaging device are adjusted by the LUT of the generic spectral model to include cross-channel interaction. The channel model then accurately predicts luminance coefficients for each channel of the imaging device based on the adjusted digital values. The generic spectral model may then convert the predicted luminance coefficients directly to a device-independent color space, such as CIE XYZ color space or CIE L*a*b* color space, without first converting to a spectral space. In other cases, the generic spectral model predicts spectral emissions for each channel of the imaging device and combines the spectral emissions of the channels into a resulting emission spectrum for a pixel of the imaging device. The resulting predicted spectrum may be further converted to a device-independent color space.

In one embodiment, the invention is directed to a method of modeling spectral characteristics of an imaging device. The method comprises adjusting digital values of each channel of the imaging device to include cross-channel interaction, predicting spectral emissions for each channel of the imaging device based on the adjusted digital values, and converting the predicted spectral emissions of the imaging device to a device-independent color space.

In another embodiment, the invention is directed to a computer-readable medium comprising instructions for modeling spectral characteristics of an imaging device. The instructions cause a processor to adjust digital values of each channel of the imaging device to include cross-channel interaction, predict spectral emissions for each channel of the imaging device based on the adjusted digital values, and convert the predicted spectral emissions of the imaging device to a device-independent color space. The adjustment of digital values, for example, may comprise application of a look-up table.

The invention may be capable of providing one or more advantages. For example, the generic spectral model described herein includes only generic physical properties of imaging devices such that it can be applied to a variety of imaging devices, unlike conventional physical models. The generic spectral model may also include a LUT in order to compensate for cross-channel interaction and non-linearity. The LUT may be relatively small compared to a conventional brute force model. In this way, the generic spectral model delivers accurate spectral predictions exhibiting reduced interpolation and measurement noise related artifacts typically associated with LUT-based models.

Furthermore, the generic spectral model can predict output of the imaging device in a device-independent color space. In this way, the processing step of calculating the total emission spectra of an imaging device may be eliminated. For example, the generic spectral model may produce as few as six coefficients that can be directly converted to a device-independent color space. At the same time, spectral output of the generic spectral model may include tens or even hundreds of points, which may then be converted to a device-independent color space. Therefore, the direct conversion process described herein reduces the number of computations required to convert the predicted spectral emissions to a device-independent color space and can also reduce processor usage.

In addition to modeling spectra of imaging devices, the generic spectral model described herein may also be used within a color management framework. The generic spectral model may be used in building ICC (International Color Consortium) profiles, and the characterization and calibration of imaging devices. The generic spectral model may be implemented as software modules within an imaging device software package or as firmware or hardware modules within some imaging devices, e.g., high-definition televisions, plasma displays, and LCDs.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating a generic spectral model capable of emulating output of an imaging device.

FIG. 2 is a block diagram illustrating an exemplary generic spectral model applied to an imaging device in accordance with an embodiment of the invention.

FIG. 3 is a flow chart illustrating an example operation of the generic spectral model from FIG. 2.

FIGS. 4A-4C are plots illustrating predicted spectral emission accuracy for each channel of an imaging device with a prior art spectral model.

FIG. 5 is a histogram illustrating a total distribution of prediction errors of the prior art spectral model.

FIGS. 6A-6C are plots illustrating predicted spectral emission accuracy for each channel of an imaging device with a basis functions spectral model.

FIG. 7 is a histogram illustrating a total distribution of prediction errors of the basis functions spectral model.

FIG. 8 is a histogram illustrating a total distribution of prediction errors of a generic spectral model applied to an imaging device in accordance with an embodiment of the invention.

FIG. 9 is a histogram illustrating a total distribution of prediction errors of a generic spectral model applied to an imaging device in accordance with another embodiment of the invention.

### DETAILED DESCRIPTION

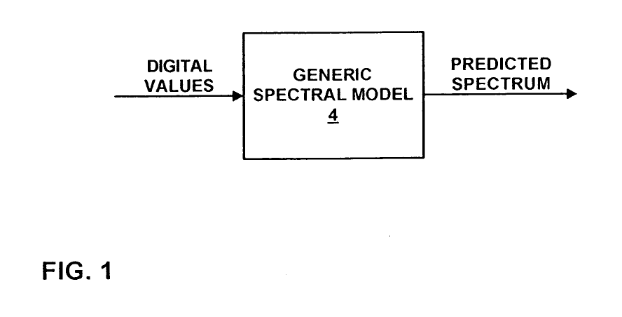

FIG. 1 is a block diagram illustrating a generic spectral model 4 capable of emulating output of an imaging device. The imaging device may include a cathode ray tube (CRT) display, a liquid crystal display (LCD), a plasma display, a digital light processing (DLP) display, digital paper, photographic material, or any device that renders images to a user. The imaging device may comprise a multi-channel device in the sense that multiple physical color channels represent every pixel on the display. For example, the imaging device may be an additive device comprising red, green, and blue (RGB) channels, or a subtractive device comprising cyan, magenta, yellow, and black (CMYK) channels.

Generic spectral model 4 receives digital values, i.e., pixel counts, for each color channel of the imaging device and predicts spectral emissions of the imaging device. As described in more detail below, generic spectral model 4 may include a general channel model capable of modeling spectral characteristics of the imaging device and a look-up table (LUT) capable of compensating cross-channel interaction and other difficult to model, e.g., non-linear characteristics of the imaging device.

The predicted spectral emissions are converted to a device-independent color space, such as CIE XYZ or CIE L*a*b*. In some cases, generic spectral model 4 may generate the prediction directly in the device-independent color space without entering the spectral domain. In this way, the processing step of calculating the total emission spectra of the imaging device may be eliminated. For example, the total emission spectrum may be represented by as few as six coefficients converted into the device-independent color space coordinates. In spectral space, however, the same spectral emission may include approximately tens or hundreds of values, which may then be converted to a device-independent color space. Therefore, the direct conversion process can reduce the amount of computational processing and memory usage, which is desirable.

Generic spectral model 4 includes benefits of both a conventional physical model and a conventional brute force model while suppressing their respective weaknesses. For example, generic spectral model 4 includes only generic physical properties of imaging devices such that it is highly adaptable to a variety of imaging devices, unlike conventional physical models. In addition, generic spectral model 4 delivers accurate spectral predictions with fewer measurements, unlike conventional pure LUT-based models. Moreover a LUT-based model requires a considerable amount of memory for storage and processing power for interpolation in spectral space.

Generic spectral model 4 may be implemented as software modules within a software package for an imaging device. A processor, such as a digital signal processor (DSP), may execute instructions stored in a computer-readable medium to perform various functions described herein. Exemplary computer-readable media may include or utilize magnetic or optical tape or disks, solid state volatile or non-volatile memory, including random access memory (RAM), read only memory (ROM), electronically programmable memory (EPROM or EEPROM), or flash memory, as well as other volatile or non-volatile memory or data storage media. In other embodiments, generic spectral model 4 may be implemented as firmware or hardware modules within some modern imaging devices. Exemplary computer hardware may include programmable processors such as microprocessors, Application-Specific Integrated Circuits (ASIC), Field-Programmable Gate Arrays (FPGA), or other equivalent integrated or discrete logic circuitry.

In addition to modeling spectra of imaging devices, generic spectral model 4 can also be used within a color management framework. For example, the predicted spectrum for an imaging device may be output from generic spectral model 4 to a color correction module (CCM). A CCM typically facilitates color matching between destination imaging devices and source imaging devices. In this case, generic spectral model 4 may be used in building ICC (International Color Consortium) profiles, and the characterization and calibration of imaging devices.

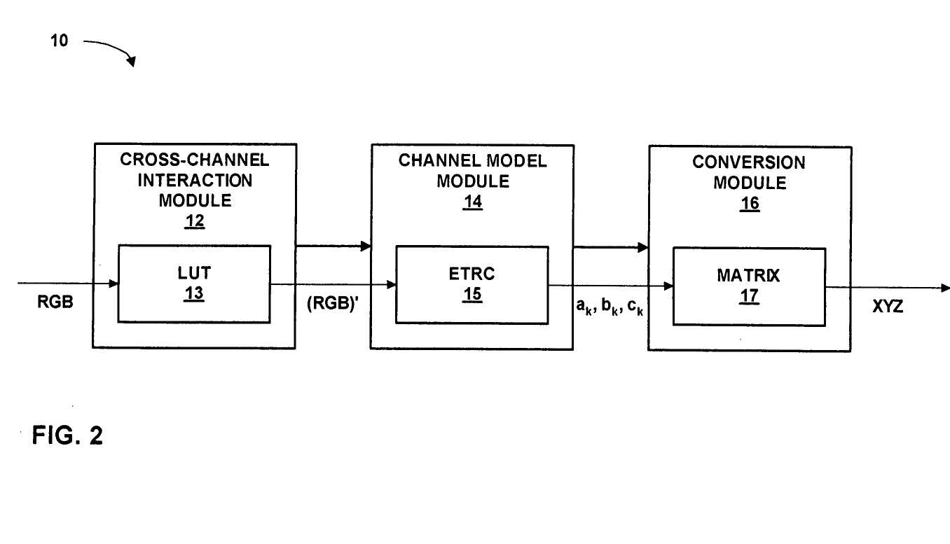

FIG. 2 is a block diagram illustrating an exemplary generic spectral model 10 applied to an imaging device in accordance with an embodiment of the invention. Generic spectral model 10 may operate substantially similar to generic spectral model 4 from FIG. 1. Generic spectral model 10 comprises cross-channel interaction module 12, channel model module 14, and conversion module 16.

Some imaging devices, e.g., CRT displays, comprise near linear devices. In other words, the normalized spectral power distribution within the visible part of the emission spectra is independent of digital values of the imaging device. The digital values control the amount of light emitted by each channel of the imaging device, but not the imaging device spectrum. Therefore, the spectral emission I(d, λ) of any channel of a linear imaging device can be expressed as a product of wavelength-dependent (λ) portions and digital value-dependent (d) portions:
Iᵢ(d,λ)=L(dᵢ)*Sⁱ(λ), (1)
where Sⁱ is normalized spectral power distribution for channel i and L is a coefficient linearly related to luminance of the channel. Additionally, typical linear imaging devices exhibit little or no cross-channel interaction. Therefore, the spectral emission of a pixel of an imaging device with RGB channels is a sum of spectral emissions of the constituting channels and is given by equation (2).
I(dr,dg,db,λ)=ρ(dᵣ)*S^{r}(λ)+γ(d_{g})*S^{g}(λ)+β(d_{b})*S^{b}(λ). (2)

A tone reproduction curve (TRC) may be used to relate the digital values to actual luminance. A TRC maps each digital value to a single luminance coefficient, L. The goal of a TRC is to provide a more uniform luminance resolution across the range of digital values. The gamma curve comprises a typical tone reproduction function, e.g., L□d^{γ}, where L is luminance, d denotes digital value, and γ is a parameter (normally 1.8 for Macintoshes and 2.2. for PCs).

However, some imaging devices exhibit significant deflection from the additive and linear behavior exhibited by equations (1) and (2). For example, an uncorrected LCD may have substantially non-linear channel emissions, e.g., Iᵢ(d, λ)∝cos²(δ(dᵢ,λ)). The non-linearity extends to both digital value portions and wavelength portions of the spectral emissions. Moreover, non-linear imaging devices often exhibit cross-channel interaction. Generic spectral model 10 accommodates a variety of imaging devices by addressing non-linearity, cross-channel interaction, and fast transformation into a device-independent color space. In the illustrated embodiment, generic spectral model 10 is applied to an additive imaging device that includes a red channel, a blue channel, and a green channel. In other embodiments, generic spectral model 10 may be applied to a subtractive imaging device that includes a cyan channel, a magenta channel, a yellow channel, and a black channel.

Cross-channel interaction module 12 receives digital values of each channel, RGB, of the imaging device. Cross-channel interface module 12 includes a LUT 13 that models cross-channel interaction. LUT 13 may also model general non-linearity and difficult to model spectral characteristics that cannot be captured by channel model module 14. Many imaging devices, for example LCDs, exhibit cross-channel interaction. Cross-channel interaction involves mutual influence of channel signals on each other. For example, the signal applied to the red channel affects emission levels in both the green and blue channels. Typically each channel cross-influences the other channels of an imaging device. Cross-channel interaction is a complex process and may significantly differ between imaging devices.

Cross-channel interaction may be attributed to real physical behavior of an imaging device and/or failure of a spectral model to capture spectral behavior of an imaging device to the full extent. An example of real physical cross-channel interaction is an LCD that operates based on in-plane-switching (IPS) technology. In LCDs that utilize IPS technology, electrodes controlling the electrical fields in the liquid crystal cells are positioned in one plane. Such positioning results in overlap of electrical fields within neighboring cells and channels of the LCD. Thus, the electrical field of the red channel affects the electrical fields of the green and blue channels and vice versa.

A mathematical model of cross-channel interaction may be expressed as a mapping from RGB to (RBG)′. In other words, the digital values within the RGB color space are mapped to adjusted digital values within the same RGB color space. This mapping reflects the difference between signals applied to an imaging device and actual emission spectra of the imaging device. However, the mapping function depends on physics of the imaging device that may not be readily available. Therefore, the mapping may be represented as LUT 13, which is capable of mapping RGB digital values to adjusted (RGB)′ digital values. (RGB)′ is an RGB digital value adjusted to include cross channel interaction. In general, LUT 13 maps a color space to itself. For example, RGB is mapped to (RGB)′ and CMYK is mapped to (CMYK)′.

LUT 13 may be generated with a plurality of nodes that correspond to measurements of the imaging device. In this way, LUT 13 presents a tradeoff between accuracy and processing speed. For example, a larger number of nodes may be included in LUT 13 to improve spectral prediction accuracy of generic spectral model 10. However, increasing the number of nodes of LUT 13 also increases processor usage to generate the estimated spectrum. On the other hand, fewer measurements may be used to generate a relatively small number of nodes within LUT 13. The reduced number of nodes of LUT 13 enables fast processing while sacrificing some spectral prediction accuracy.

Channel model module 14 receives adjusted digital values of each channel, (RGB)′, from cross-channel interaction module 12. Channel model module 14 predicts spectral emissions for each channel of the imaging device based on the adjusted digital values. Channel model module 14 does not explicitly assume any specific physical behavior of an imaging device and thus is very stable to calibration procedures and adaptable to a wide variety of imaging devices and technologies.

Channel model module 14 includes an extended TRC (ETRC) 15. ETRC 15 is generated with a plurality of nodes; each of the nodes corresponds to a unique digital value and contains at least two luminance coefficients. In other embodiments, channel model module 14 may simply include a TRC in which each node contains only one luminance coefficient. The spectral emissions for each channel are modeled as linear combinations of two or more basis functions, Sₖ(λ), scaled by corresponding luminance coefficients. The luminance coefficients of this linear combination are found using optimization methods and are stored in ETRC 15 within channel model module 14. The luminance coefficients are calculated in order to minimize differences between predicted and measured channel spectra. The number of basis functions is determined based on a desired level of accuracy of the predicted spectral emissions. The number of luminance coefficients is equal to the number of basis functions.

ETRC 15 is a vector TRC which maps each adjusted digital value to a vector of two or more luminance coefficients. For example, if channel model module 14 uses three basis functions, every node of ETRC 15 corresponds to a unique digital value and contains a vector of three luminance coefficients. Luminance coefficients may be interpolated when one of the adjusted digital values falls between nodes of ETRC 15. In addition, luminance coefficients in ETRC 15 may be smoothed in order to reduce measurement or other noise.

As discussed above, many imaging devices exhibit non-linear behavior such that the normalized spectral power distribution depends on digital values. Conventionally, spectral emissions for each channel of a non-linear imaging device may be described by trigonometric formulas that are usually only valid for specific types of imaging devices. Channel model module 14, on the other hand, accurately describes spectral emissions for each channel of the imaging device by a linear combination of basis functions:

$$I ( {d}_{i} , λ ) = {\sum }_{1}^{N} {a}_{k} ( {d}_{i} ) * {S}_{k}^{i} ( λ ) , \qquad ( 3 )$$

where Sⁱₖ is the basis functions for channel i and aₖ is the luminance coefficients mapped from adjusted digital value d by ETRC 15, i.e., d→ETRC→{aₖ} and N is the number of basis functions and the number of luminance coefficients. As described above, N is determined based on a desired level of accuracy of the predicted spectral emissions I(dᵢ, λ). As can be seen from equation (3), I(dᵢ, λ) is a linear interpolation in space of the Sⁱₖ functions.

Most imaging devices are additive or subtractive at least to some extent. For example, an imaging device may have three independent color channels, namely red, green, and blue. Total spectral emission delivered by the imaging device is the sum of all three channel spectral emissions. Such additive behavior is characteristic for a wide variety of imaging devices. For example, the total spectral emission for an additive RGB imaging device is given by equation (4).

$$I ( dr , d g , db , λ ) = {\sum }_{1}^{N} ( {a}_{k} ( {d}_{r} ) * {S}_{k}^{r} ( λ ) + {b}_{k} ( {d}_{g} ) * {S}_{k}^{g} ( λ ) + {c}_{k} ( {d}_{b} ) * {S}_{k}^{b} ( λ ) ) . \qquad ( 4 )$$

Superscripts and subscripts r, g, and b denote corresponding red, green, and blue channels. Equation (4) converts digital values to spectral space.

In some embodiments, a mixing module (not shown) may receive the predicted spectral emissions for each channel from channel model module 14. An emission spectrum for the imaging device is measured based on a wavelength grid and may include tens of hundreds values. Operating in spectral domain means processing all these values. Therefore, conversion to spectral space requires large amounts of computational processing and memory usage.

In the illustrated embodiment, conversion module 16 receives luminance coefficients aₖ, bₖ, and cₖ mapped from adjusted digital values dᵣ, d_{g}, and d_{b}, respectively, by ETRC 15 from channel model module 14. Conversion module 16 includes a matrix 17 that converts the luminance coefficients directly to a device-independent color space, such as CIE XYZ or CIE L*a*b*, without entering spectral space. In this way, the spectral emission of the imaging device may be represented by only six luminance coefficients.

The conversion from luminance coefficients to device-independent color space may be encoded as matrix to vector multiplication. For example, CIE XYZ color space may be calculated directly from luminance coefficients mapped by ETRC 15 by performing a vector-matrix operation.

Conversion module 16 converts the predicted spectral emissions to device-independent tristimulus values, i.e., CIE XYZ color space, by convolving the spectral emissions with color matching functions x, y, and z.

$$X = \frac{1}{K} \int I ( dr , d g , db , λ ) \overline{x} ( λ ) ⅆ λ \\ Y = \frac{1}{K} \int I ( dr , d g , db , λ ) \overline{y} ( λ ) ⅆ λ \\ Z = \frac{1}{K} \int I ( dr , d g , db , λ ) \overline{z} ( λ ) ⅆ λ \qquad ( 5 )$$

Substituting equation (4) into equation set (5) results in:

$$X = \frac{1}{K} \int \overline{x} ( λ ) * {\sum }_{1}^{N} ( {a}_{k} ( {d}_{r} ) * {S}_{k}^{r} ( λ ) + {b}_{k} ( {d}_{g} ) * {S}_{k}^{g} ( λ ) + {c}_{k} ( {d}_{b} ) * {S}_{k}^{b} ( λ ) ) ⅆ λ \\ Y = \frac{1}{K} \int \overline{y} ( λ ) * {\sum }_{1}^{N} ( {a}_{k} ( {d}_{r} ) * {S}_{k}^{r} ( λ ) + {b}_{k} ( {d}_{g} ) * {S}_{k}^{g} ( λ ) + {c}_{k} ( {d}_{b} ) * {S}_{k}^{b} ( λ ) ) ⅆ λ \\ Z = \frac{1}{K} \int \overline{z} ( λ ) * {\sum }_{1}^{N} ( {a}_{k} ( {d}_{r} ) * {S}_{k}^{r} ( λ ) + {b}_{k} ( {d}_{g} ) * {S}_{k}^{g} ( λ ) + {c}_{k} ( {d}_{b} ) * {S}_{k}^{b} ( λ ) ) ⅆ λ . \qquad ( 6 )$$

Summation can then be brought outside of the integrals as shown by equation set (7).

$$X = \frac{1}{K} {\sum }_{1}^{N} ( {a}_{k} ( {d}_{r} ) * \int \overline{x} ( λ ) * {S}_{k}^{r} ( λ ) ⅆ λ + {b}_{k} ( {d}_{R} ) * \int \overline{x} ( λ ) * {S}_{k}^{R} ( λ ) ⅆ λ + {c}_{k} ( {d}_{b} ) * \int \overline{x} ( λ ) * {S}_{k}^{b} ( λ ) ⅆ λ ) \\ Y = \frac{1}{K} {\sum }_{1}^{N} ( {a}_{k} ( {d}_{r} ) * \int \overline{y} ( λ ) * {S}_{k}^{r} ( λ ) ⅆ λ + {b}_{k} ( {d}_{R} ) * \int \overline{y} ( λ ) * {S}_{k}^{R} ( λ ) ⅆ λ + {c}_{k} ( {d}_{b} ) * \int \overline{y} ( λ ) * {S}_{k}^{b} ( λ ) ⅆ λ ) \\ Z = \frac{1}{K} {\sum }_{1}^{N} ( {a}_{k} ( {d}_{r} ) * \int \overline{z} ( λ ) * {S}_{k}^{r} ( λ ) ⅆ λ + {b}_{k} ( {d}_{R} ) * \int \overline{z} ( λ ) * {S}_{k}^{R} ( λ ) ⅆ λ + {c}_{k} ( {d}_{b} ) * \int \overline{z} ( λ ) * {S}_{k}^{b} ( λ ) ⅆ λ ) \qquad ( 7 )$$

The first equation of equation set (7) can be also written in algebraic form as:
X=(a*sx^{r}+b*sx^{g}+c*sx^{b}), (8)
where a, b, and c are vectors of coefficients {aₖ}, {bₖ}, and {cₖ} for the red, green and blue channels of the imaging device, and sxⁱ is a vector comprising inner dot products, i.e., integral convolutions, of color matching function x(λ) and basis functions Sₖ(λ) for the i-th channel, where the k-th element of the vector is given by equation (9).

$${sx}_{k}^{r} = \frac{1}{K} \int \overline{x} ( λ ) * {S}_{k}^{r} ( λ ) ⅆ λ \qquad ( 9 )$$

Every element of sx corresponds to one basis function Sₖ(λ), thus the number of elements of sx is equal to the number of basis functions.

Equation (8) may be also written as:
X=sx^{rgb}*abc, (10)
where sx^{rgb} is a row vector concatenated from sx^{r}, sx^{g}, and sx^{b},
sx^{sgb}=|sx^{r} sx^{g} sx^{b}|, (11)
and abc is a column vector concatenated from a, b, and C.

Algebraic forms for the Y and Z formulas are substantially similar to equation (10) for the X formula:

$$\begin{matrix}\begin{matrix}X = {sx}^{rgb} * abc \\ Y = {sy}^{rgb} * abc \\ Z = {sz}^{rgb} * abc\end{matrix} \\ or & ( 12 ) \\ \vert \begin{matrix}X \\ Y \\ Z\end{matrix} \vert = M * abc ≡ \vert \begin{matrix}{sx}^{rgb} \\ {sy}^{rgb} \\ {sz}^{rgb}\end{matrix} \vert * abc . & ( 13 )\end{matrix}$$

The three rows of matrix M 17 are formed by the row vectors sx^{rgb}, sy^{rgb}, and sz^{rgb}. Matrix 17 has dimensions 3N by 3 and the vector abc has dimensions 3N. As discussed above, N is the number of basis functions based on a desired level of accuracy of the predicted spectral emissions. If processing requires, elements of matrix M 17 and vector abc can be rearranged as long as the final computations satisfy equation set (7). For example, vector abc can be combined by interleaving a, b, and c, instead of concatenating them. In that case, rows of matrix M 17 also should be formed by interleaving elements of sx^{r}, sx^{g}, and sx^{b}. The described rearrangements leave actual calculations unchanged and in accordance with equation set (7).

Generic spectral model 10 contains three standard modules 12, 14, and 16, All the modules can be substantially optimized since they are device-independent and data processing is identical for all imaging devices. Generic spectral model 10 is capable of predicting spectral emissions for a wide variety of imaging devices with accuracy and mathematical complexity that is predictable and adaptive.

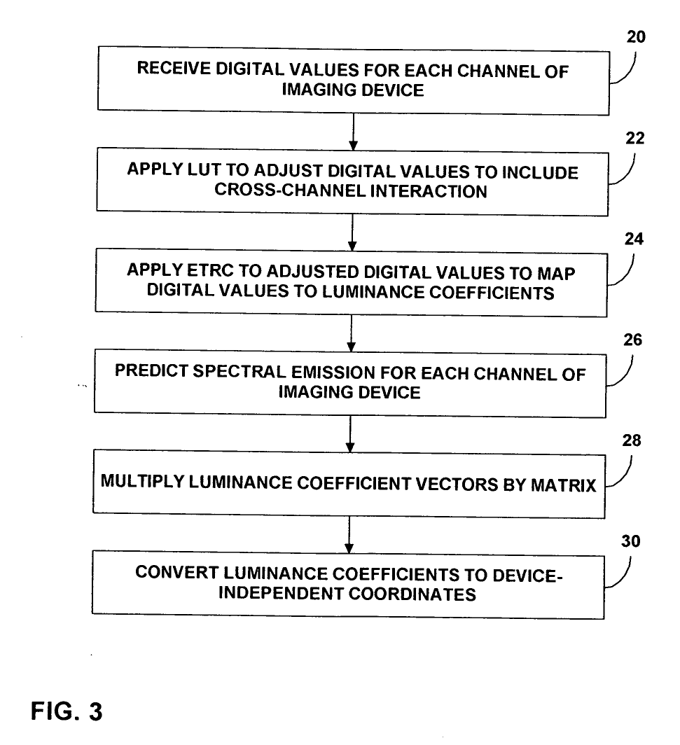

FIG. 3 is a flow chart illustrating an example operation of generic spectral model 10 from FIG. 2. Cross-channel interaction module 12 receives digital values for each channel, e.g., RGB digital values, of an imaging device (20). Examples of imaging devices include cathode ray tube (CRT) displays, liquid crystal displays (LCD), plasma displays, digital light processing (DLP) displays, digital paper, photographic materials, or any device that renders images to a user. Cross-channel interaction module 12 applies LUT 13 to the digital values. LUT 13 adjusts the received digital values to include cross-channel interaction (22). LUT 13 may also adjust the digital values to include non-linearity and other spectral characteristics not compensated by channel model module 14.

Channel model module 14 receives the adjusted digital values, (RGB)′, from cross-channel interaction module 12. Channel model module 14 applies ETRC 15 to the adjusted digital values. ETRC 15 maps each of the adjusted digital values to two or more luminance coefficients (24). Channel model module 14 may then predict spectral emission for each channel of the imaging device by linearly combining two or more basis functions, Sₖ(λ), of the channel scaled by the corresponding luminance coefficients (26). The number of basis functions and luminance coefficients are based on a desired level of accuracy of the predicted spectral emissions.

Conversion module 16 receives the luminance coefficients aₖ, bₖ, and cₖ mapped from the adjusted digital values by ETRC 15 of channel model module 14. Conversion module 16 multiplies vectors of the luminance coefficients by matrix 17, which includes inner dot products, i.e., integral convolutions, of color matching functions and basis functions for each channel of the imaging device (28). In this way, conversion module 16 directly converts the luminance coefficients to a device-independent color space, such as CIE XYZ or CIE L*a*b*, without entering spectral space (30).

In other embodiments, a mixing module may receive the predicted emission spectra for each channel of the imaging device from channel model module 14. The mixing module then calculates spectral emission output for the imaging device. For example, equation (4) given above provides an example spectral calculation for a simple additive RGB model.

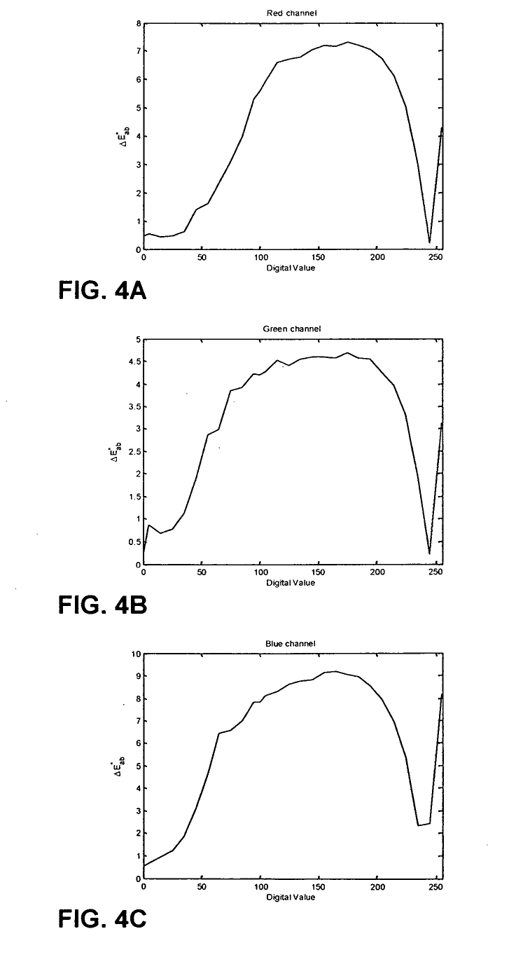

FIGS. 4A-4C are plots illustrating predicted spectral emission accuracy for each channel of an imaging device with a prior art spectral model. The imaging device of the illustrated example comprises an LCD that includes a red channel, a green channel, and a blue channel. The prior art spectral model applies a TRC to digital values of each channel of the imaging device and directly converts the predicted spectral emissions to a device-independent color space. As described above, a TRC maps each digital value to a single luminance coefficient. Therefore this prior art model is incapable of modeling non-linearity in the imaging device.

FIG. 4A plots error, i.e., ΔE, between predicted spectral emissions and measured spectral emissions for digital values of the red channel of the imaging device. The digital values comprise pixel counts for the corresponding channels that range from 0 to 255. Delta E is a well known parameter in the art of color science that refers to the Euclidean distance in CIE L*a*b* space between two measured colors. This Euclidean distance is scaled such that a unit of 1 ΔE approximates a color difference that the human eye can detect. FIG. 4B plots error, i.e., ΔE, between predicted spectral emissions and measured spectral emissions for digital values of the green channel of the imaging device. FIG. 4C plots error, i.e., ΔE, between predicted spectral emissions and measured spectral emissions for digital values of the blue channel of the imaging device.

As can be seen, the error levels are unsatisfactory with a maximum ΔE equal to approximately 9. Ideally, ΔE should be equal to approximately 1 or less than 1. The high error level may be due in part to the non-linear nature of the LCD. FIGS. 4A-4C demonstrate that the prior art linear spectral model is incapable of capturing spectral characteristics of some non-linear imaging device.

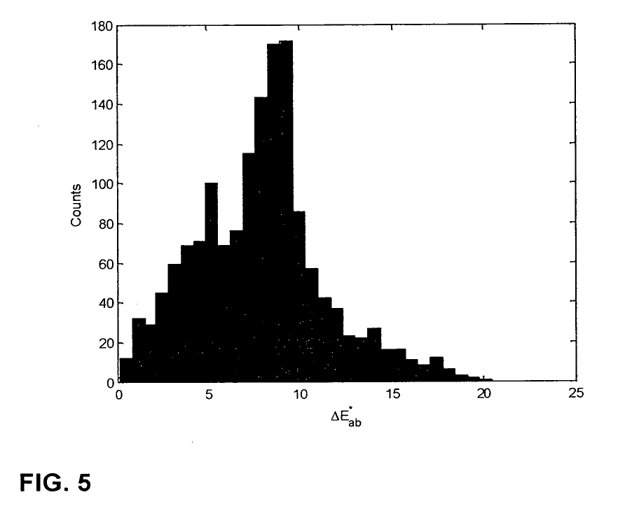

FIG. 5 is a histogram illustrating a total distribution of prediction errors of the prior art spectral model. FIG. 5 plots counts for specific error levels of ΔE. Both the maximum error level of approximately 25 and the mean error of approximately 9 are too high for graphic art applications.

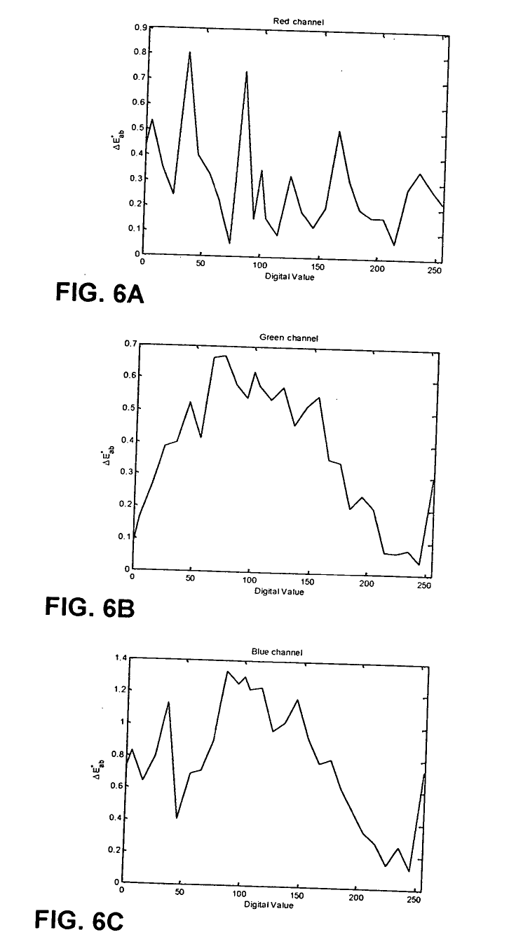

FIGS. 6A-6C are plots illustrating predicted spectral emission accuracy for each channel of an imaging device with a basis functions spectral model. The imaging device of the illustrated example comprises an LCD that includes a red channel, a green channel, and a blue channel. The basis functions spectral model applies an ETRC to digital values of each channel of the imaging device and directly converts the predicted spectral emissions to a device-independent color space. The basis functions spectral model may be defined by equation (3) given above including two basis functions, i.e., N=2. In this case, the ETRC maps each digital value to two luminance coefficients.

FIG. 6A plots error, i.e., ΔE, between predicted spectral emissions and measured spectral emissions for digital values of the red channel of the imaging device. The digital values comprise pixel counts for the corresponding channels that range from 0 to 255. FIG. 6B plots error, i.e., ΔE, between predicted spectral emissions and measured spectral emissions for digital values of the green channel of the imaging device. FIG. 6C plots error, i.e., ΔE, between predicted spectral emissions and measured spectral emissions for digital values of the blue channel of the imaging device. As can be seen, the error levels are significantly improved with a maximum ΔE equal to approximately 1.4, compared to the prior art spectral model illustrated in FIGS. 4A-4C. Clearly, the addition of one basis function to the channel model allows compensation of channel non-linearity in the imaging device.

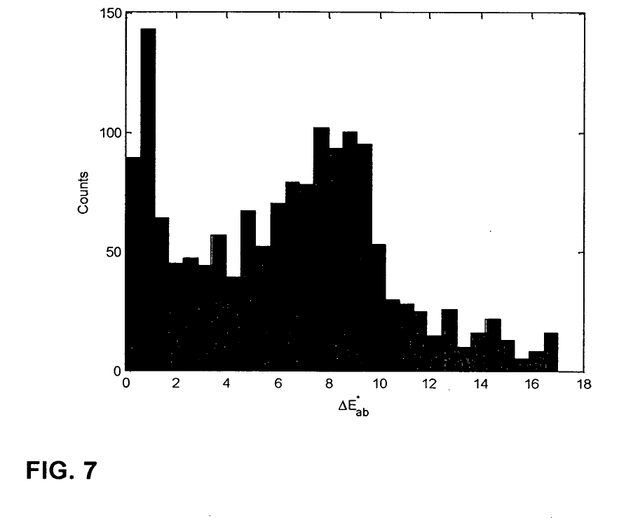

FIG. 7 is a histogram illustrating a total distribution of prediction errors of the basis functions spectral model. FIG. 7 plots counts for specific error levels of ΔE. Although the basis functions spectral model provides an accurate channel model as shown in FIGS. 6A-6C, the overall accuracy of the basis functions spectral model is still too high for many graphic art applications. As can be seen, the maximum error level of ΔE is approximately 17 and the mean error level is approximately 6.

One major problem with the basis functions spectral model may lay in cross-channel interaction, i.e., interference of channel signals. As described above, cross-channel interaction is a complex process and may significantly differ from one imaging device to another. One way to account for this effect is a look-up table.

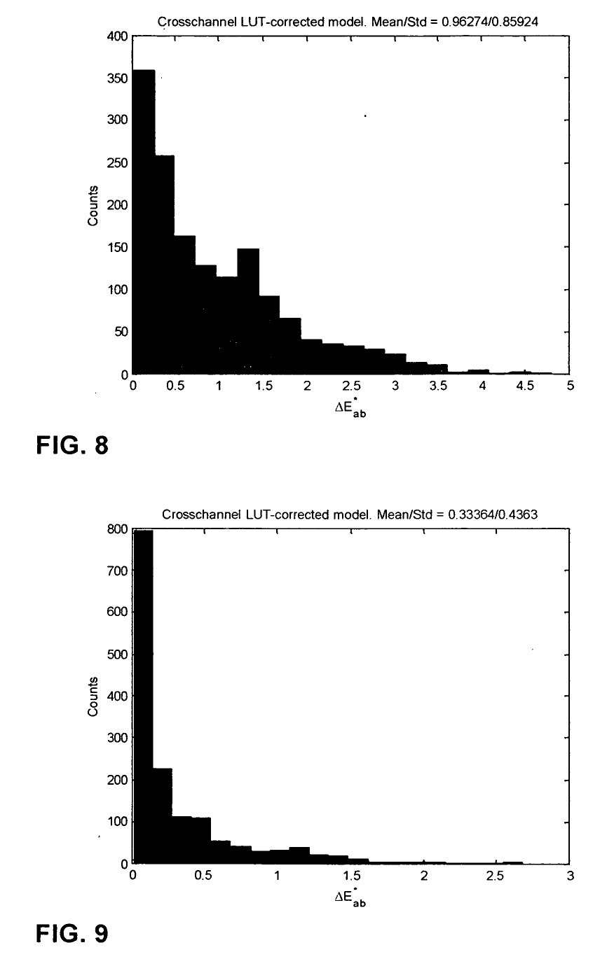

FIG. 8 is a histogram illustrating a total distribution of prediction errors of a generic spectral model applied to an imaging device in accordance with an embodiment of the invention. The imaging device of the illustrated example comprises an LCD that includes a red channel, a green channel, and a blue channel. The generic spectral model may be substantially similar to generic spectral model 10 from FIG. 2. The generic spectral model applies a LUT to digital values of each channel of the imaging device that adjusts the digital values to include cross-channel interaction. The generic spectral model then applies an ERTC to the adjusted digital values and directly converts the predicted spectral emissions to a device-independent color space. In this case, the channel model again includes two basis functions, i.e., N=2, such that the ETRC maps each digital value to two luminance coefficients.

The histogram of FIG. 8 plots counts for specific error levels of ΔE. In the illustrated embodiments, the LUT of the generic spectral model comprises 6×6×6 nodes that correspond to imaging device measurements. The LUT significantly improves the overall accuracy of the predicted spectral emissions by compensating cross-channel interaction. As can be seen the maximum error level of ΔE is approximately 5 and the mean error level is approximately 1.

FIG. 9 is a histogram illustrating a total distribution of prediction errors of a generic spectral model applied to an imaging device in accordance with another embodiment of the invention. The imaging device of the illustrated example comprises an LCD that includes a red channel, a green channel, and a blue channel. The generic spectral model may be substantially similar to generic spectral model 10 from FIG. 2. The generic spectral model applies a LUT to digital values of each channel of the imaging device that adjusts the digital values to include cross-channel interaction. The generic spectral model then applies an ERTC to the adjusted digital values and directly converts the predicted spectral emissions to a device-independent color space. In this case, the channel model again includes two basis functions, i.e., N=2, such that the ETRC maps each digital value to two luminance coefficients.

The histogram of FIG. 9 plots counts for specific error levels of ΔE. In the illustrated embodiments, the LUT of the generic spectral model comprises 10×10×10 nodes that correspond to imaging device measurements. The larger LUT may increase processor usage to predict spectral emissions of the imaging device, but accuracy of the predictions are further improved. As can be seen, the maximum error level of ΔE is approximately 2.5 and the mean error level is approximately 0.3.

Various embodiments of the invention have been described. For example, a generic spectral model has been described that includes aspects of both a conventional physical model and a conventional brute force model to predict spectral emissions of an imaging device. The generic spectral model includes a general channel model capable of modeling spectral characteristics of imaging devices and a look-up table (LUT) capable of compensating cross-channel interaction and other difficult to model, e.g., non-linear characteristics of imaging devices. In addition, a generic spectral model has been described that converts predicted spectral emissions directly to a device-independent color space without entering spectral space.

In addition to modeling spectra of imaging devices, the generic spectral model described herein may be used within a color management framework. The generic spectral model may be used in building ICC (International Color Consortium) profiles, and the characterization and calibration of imaging devices. The generic spectral model may be implemented as software modules within an imaging device software package or as firmware or hardware modules within some imaging devices, e.g., modem televisions and LCDs. These and other embodiments are within the scope of the following claims.

### PARTS LIST

4 generic spectra model
10 spectral model
12 cross channel interaction module
13 LUT
14 channel model module
15 TRC (ETRC)
16 conversion module
17 matrix
20 imaging device
22 cross-channel interaction
24 luminance coefficients
26 luinance coefficients
28 imaging device
30 spectral space

1. A method of modeling spectral characteristics of an imaging device comprising:
adjusting digital values of each channel of the imaging device to include cross-channel interaction;
predicting spectral emissions for each channel of the imaging device based on the adjusted digital values; and
converting the predicted spectral emissions of the imaging device to a device-independent color space.

2. The method of claim 1, further comprising receiving digital values of each channel of the imaging device, wherein the digital values comprise pixel counts.

3. The method of claim 1, wherein adjusting the digital values comprises applying a look-up table to the digital values.

4. The method of claim 3, further comprising generating the look-up table with a plurality of nodes that correspond to measurements of the imaging device.

5. The method of claim 4, wherein an increased number of nodes in the look-up table increases accuracy of the predicted spectral emissions for each channel in the imaging device.

6. The method of claim 4, wherein a decreased number of nodes in the look-up table increases processing speed for determining the spectral emissions for each channel in the imaging device.

7. The method of claim 3, wherein the look-up table models spectral characteristics that are substantially non-uniform across different imaging devices.

8. The method of claim 1, wherein the adjusted digital values include non-linearity.

9. The method of claim 1, wherein adjusting the digital values comprises mapping the digital values within a color space to adjusted digital values within the same color space.

10. The method of claim 1, wherein predicting spectral emissions for each channel comprises applying a channel model to the adjusted digital values.

11. The method of claim 10, wherein the channel model models spectral characteristics for each channel of the imaging device that are substantially uniform across different imaging devices.

12. The method of claim 10, further comprising generating the channel model based on general physics of imaging devices.

13. The method of claim 1, further comprising applying an extended tone reproduction curve to the adjusted digital values that maps each of the adjusted digital values to two or more luminance coefficients.

14. The method of claim 13, further comprising generating the extended tone reproduction curve with a plurality of nodes, wherein each of the nodes corresponds to a digital value and contains two or more luminance coefficients.

15. The method of claim 14, wherein the number of luminance coefficients contained within each of the nodes in the extended tone reproduction curve is based on a desired level of accuracy of the predicted spectral emissions.

16. The method of claim 14, further comprising interpolating luminance coefficients when one of the adjusted digital values falls between the nodes of the extended tone reproduction curve.

17. The method of claim 1, wherein predicting spectral emissions for each channel comprises linearly combining two or more basis functions of the channel scaled by corresponding luminance coefficients.

18. The method of claim 17, wherein the number of basis functions is based on a desired level of accuracy of the predicted spectral emissions.

19. The method of claim 18, wherein the number of luminance coefficients is equal to the number of basis functions.

20. The method of claim 1, wherein converting the predicted spectral emissions comprises converting luminance coefficients directly to the device-independent color space without entering spectral space.

21. The method of claim 1, wherein converting the predicted spectral emissions comprises convolving the predicted spectral emissions with color matching functions of the device-independent color space.

22. The method of claim 21, wherein convolving the predicted spectral emissions with color matching functions comprises performing a vector-matrix operation.

23. The method of claim 1, wherein the device-independent color space comprises one of CIE XYZ color space or CIE L*a*b* color space.

24. The method of claim 1, wherein the imaging system comprises an additive system.

25. The method of claim 1, wherein the digital values of the channels of the imaging device are within a device-dependent color space.

26. The method of claim 1, wherein the imaging device comprises three channels including a red channel, a green channel, and a blue channel.

27. The method of claim 1, wherein the imaging device comprises four channels including a cyan channel, a magenta channel, a yellow channel, and a black channel.

28. The method of claim 1, wherein the imaging device comprises one of a cathode ray tube (CRT) display, a liquid crystal display (LCD), a plasma display, a digital light processing (DLP) display, or photographic materials.

29. A computer-readable medium comprising instructions for modeling spectral characteristics of an imaging device that cause a processor to:
adjust digital values of each channel of the imaging device to include cross-channel interaction;
predict spectral emissions for each channel of the imaging device based on the adjusted digital values; and
convert the predicted spectral emissions of the imaging device to a device-independent color space.

30. The computer-readable medium of claim 29, further comprising instructions that cause the processor to receive digital values of each channel of the imaging device, wherein the digital values comprise pixel counts.

31. The computer-readable medium of claim 29, wherein the instructions that cause the processor to adjust the digital values cause the processor to apply a look-up table to the digital values.

32. The computer-readable medium of claim 31, further comprising instructions that cause the processor to generate the look-up table with a plurality of nodes that correspond to measurements of the imaging device.

33. The computer-readable medium of claim 29, wherein the instructions that cause the processor to predict spectral emissions for each channel cause the processor to apply a channel model to the adjusted digital values.

34. The computer-readable medium of claim 33, further comprising instructions that cause the processor to generate the channel model based on general physics of imaging devices.

35. The computer-readable medium of claim 29, further comprising instructions that cause the processor to apply an extended tone reproduction curve to the adjusted digital values that maps each of the adjusted digital values to two or more luminance coefficients.

36. The computer-readable medium of claim 35, further comprising instructions that cause the processor to generate the extended tone reproduction curve with a plurality of nodes, wherein each of the nodes corresponds to a digital value and contains two or more luminance coefficients.

37. The computer-readable medium of claim 29, wherein the instructions that cause the processor to predict spectral emissions for each channel cause the processor to linearly combine two or more basis functions of the channel scaled by corresponding luminance coefficients.

38. The computer-readable medium of claim 29, wherein the instructions that cause the processor to convert the predicted spectral emissions cause the processor to convert luminance coefficients directly to the device-independent color space without entering spectral space.

39. The computer-readable medium of claim 29, wherein the instructions that cause the processor to convert the predicted spectral emissions cause the processor to convolve the predicted spectral emissions with color matching functions of the device-independent color space.
